(19) United States
(12) Patent Application Publication
(10) Pub. No.: US 2004/0100041 A1
(43) Pub. Date: May 27, 2004

(54) Seal for a closing part of a motor vehicle

(76) Inventors: Dirk Palicki, Hergensweiler (DE); Helmut Mayerl, Lichtenau (DE); Uwe Schneemilch, Brunnen (DE)

Correspondence Address: Stephen B. Salai, Esq., Harter, Secrest & Emery LLP, 1600 Bausch & Lomb Place, Rochester, NY, 14604-2711, US

(21) Appl. No.: 10/296,141

(22) PCT Filed: May 17, 2001
(86) PCT No.: PCT/EP01/05679

(30) Foreign Application Priority Data
May 23, 2000 (DE) 100 25 326.1

(51) Int. Cl. F16J 15/02

(52) U.S. Cl. 277/640; 277/630

(57) ABSTRACT

The present invention relates to a seal (14), more particularly for a vehicle door (10). In accordance with the invention the seal (14) is provided with at least one elastically pivotable tongue (19; 20) which on assembly clasps an assigned protuberance (22; 23) in thus assuring fast, simple and reliable securement of the seal (14).

The present invention relates to a seal for a closure part of a vehicle.

Such seals are known in many and varied designs. One disadvantage of these known seals is that in some cases a screw is needed for securement and location which complicates installation in necessitating additional steps therein. Apart from this, the screw, as a rule, remains visible on one side.

It is thus the objective of the present invention to provide a seal permitting faster and simpler securement and removable without the need of a tool.

In accordance with the invention this objective is achieved for a seal of the aforementioned kind in that the seal is provided with at least one elastically pivotable tongue which on assembly clasps an assigned protuberance.

The tongue provided in accordance with the invention enables the seal to be secured without a tool and without any additional steps in fitting in thus totally eliminating the screw used hitherto. The result is thus speedy and simple assembly and removal. Furthermore, a smooth streamline finish to the outer and inner side of the door is achieved.

Advantageous aspects and further embodiments of the invention read from the sub-claims.

To advantage, the seal is provided with a latching element comprising at least one tongue. The latching element is produced in a suitable material separate from the seal and subsequently connected thereto. This separate production permits optimum material adaptation.

In one advantageous further embodiment the latching element comprises a base body with a cavity on which the at least one tongue is linked elastically pivotable. In this arrangement, the base body and the tongue are each configured to advantage elastically pivotable to the other. The cavity furnishes a secure connection between the latching element and the seal whilst ensuring the necessary skewing action of the tongue.

In accordance with one advantageous aspect the base body and the at least one tongue are configured materially integral in thus enabling the latching element to be produced in one piece and connected to the seal.

Advantageously the seal is configured as a window seal for the moveable window of a vehicle door. In this case the latching element may be disposed more particularly in the region of the B pillar of the vehicle. However, the seal in accordance with the invention may just as well be configured as a door cavity seal for a moveable window or for some other closure part such as a door, engine hood or trunk lid.

In another advantageous aspect the seal is provided with two elastically pivotable tongues to make for better securement and location.

In accordance with another further embodiment the two tongues are disposed at an angle to each other. Due to this angular setting the latching element is located in two directions for thus providing location in the desired securement plane to prevent the latching element and thus the seal from being shifted out of place.

In yet another advantageous aspect the angle between the two tongues corresponds to the angle between parts of the frame to which the latching element is secured. This makes for reliable securement with simplified assembly.

To advantage, the at least one tongue is provided with an attachment for contacting the assigned protuberance. This attachment makes for a defined securement position of the tongue in thus avoiding any prohibitively excessive skewing action of the tongue. Furthermore, the tongue may also be additionally elastically pretensioned in the securement position. In this case, after assembly the seal is drawn against the door by the pretension. Even with a gradual deeterioration of the pretension in the lifetime of the seal a secure, reliable securement remains assured.

The latching element may be made of metal or a hard plastics material. These materials furnish the necessary elasticity and stiffness despite their low weight.

The subject matter of the invention will now be detailed by way of an example embodiment as a window seal, without being restricted to this application, and as illustrated diagrammatically in the drawing in which:

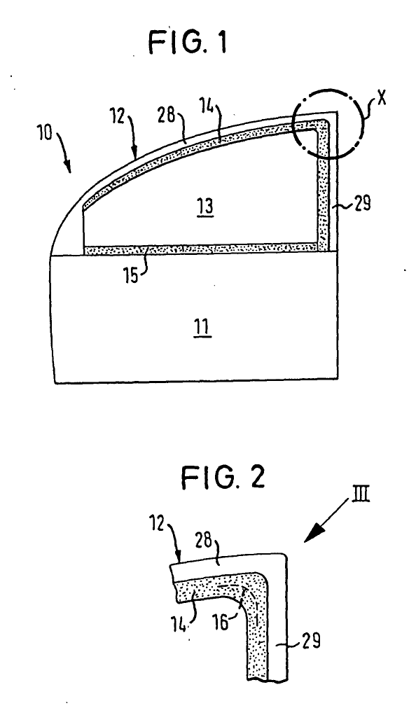

FIG. 1 is a side view of a vehicle door;

FIG. 2 is a magnified view of the detail X as shown in FIG. 1:

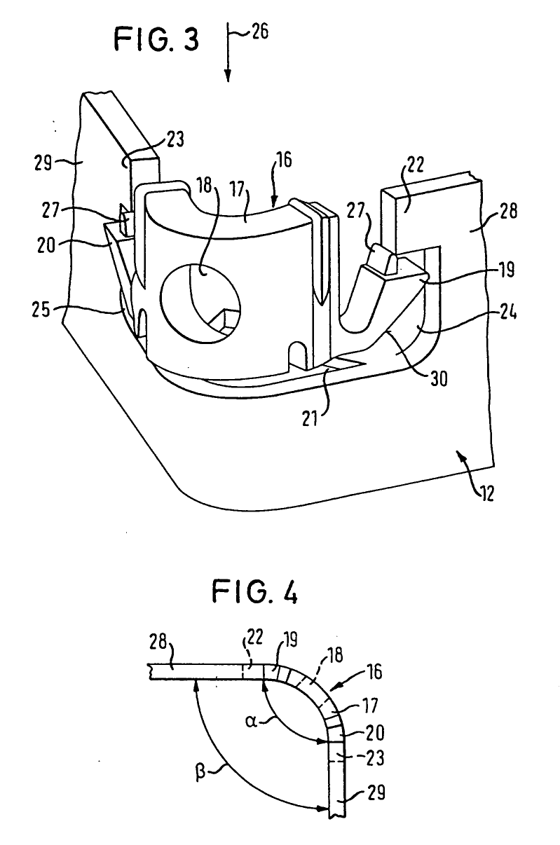

FIG. 3 is a view in perspective of a latching element employed in a door frame as viewed in the direction of the arrow III in FIG. 2; and

FIG. 4 is a plan view of FIG. 3.

Referring now to FIG. 1 there is illustrated in a side view a door 10 of a vehicle including a door panel 11 and a frame 12. The frame 12 comprises two frame parts 28, 29. Between the door panel 11 and the frame 12 a moveable window pane 13 is accommodated. For guiding and sealing the pane 13 a frame seal 14 as well as a door cavity seal 15 are provided.

Referring now to FIG. 2 there is illustrated a magnified view of the detail X as shown in FIG. 1 in the region of the B pillar. The frame seal 14 is provided with a latching element 16 in the corner between the frame parts 28, 29. The latching element 16 affords a secure and reliable fastening of the frame seal 14 in the transition between the frame parts 28, 29.

Referring now to FIGS. 3 and 4 there are illustrated further details of the latching element 16. The latching element 16 comprises a base body 17 and a cavity 18 as well as two tongues 19, 20. The base body 17 and the tongues 19, 20 are configured materially integral. In this arrangement the tongues 19, 20 are directed elastically pivotable in contact with the base body 17. Each of the tongues 19, 20 is provided with an attachment 27. The base body 17 and the tongues 19, 20 in this arrangement are configured rigidly and elastically pivotable to each other.

The frame 12 of the door 10 comprises in the transition between the frame parts 28, 29 a cavity 21. The cavity 21 is large enough to accommodate the latching element 16. For locating the tongues 19, 20 the frame parts 28, 29 are provided with protuberances 22, 23. The protuberances 22, 23 form undercuts 24, 25 serving to receive the tongues 19, 20.

For assembly the frame seal 14 together with the latching element 16 is inserted in the direction of the arrow 26 into the cavity 21, the tongues 19, 20 contacting the protuberances 22, 23 in being skewed towards the base body 17. To assist skewing the tongues 19, 20 feature a slanting face 30.

On further movement in the direction of the arrow 26 the tongues 19, 20 gain access to the undercuts 24, 25, they then being skewed away elastically from the base body 17 until the attachments 27 come into contact with the protuberances 22, 23 to thus ensure a defined assembly position of the tongues 19, 20. More particularly, the tongues 19, 20 may be pretensioned in the assembly position.

The cavity 18 of the base body 17 lightens the weight of the latching element 16. Furthermore, the cavity 18 is made of the same material as the frame seal 14 in the production thereof, as a result of which the latching element 16 is reliably located relative to the frame seal 14.

The tongues 19, 20 of the latching element 16 are disposed at an angle to each other. The angle α between the tongues 19, 20 corresponds to an angle β between the frame parts 28, 29. This angle arrangement makes for a better securement and location whilst reliably preventing the latching element 16 from shifting out of place. The substantially identical angles α, β ensure that the tongues 19, 20 are reliably accommodated in the undercuts 24, 25.

The latching element 16 is made of metal, preferably of a light alloy, or of a hard plastics material, separate from the frame seal 14 for connection thereto in thus permitting optimum adaptation to the circumstances in each case.

The frame seal 14 in accordance with the invention permits fast and simple securement. Separate fasteners such as screws are no longer needed, in thus eliminating these additional steps in assembly.

1. A seal for a closure part (10; 13) of a vehicle, comprising a latching element (16) provided with at least one tongue (19; 20) configured elastically pivotable to clasp an assigned protuberance (22; 23) disposed on a frame (12) of the closure part (10; 13).

2. The seal as set forth in claim 1, characterized in that the latching element (16) comprises a base body (17) on which the tongue (19; 20) is linked elastically pivotable.

3. The seal as set forth in claim 2, characterized in that the base body (17) is provided with a cavity (18).

4. The seal as set forth in claim 2 or 3, characterized in that the base body (17) and the tongue (19; 20) are configured materially integral.

5. The seal as set forth in any of the claims 2 to 4, characterized in that base body (17) and the tongue (19, 20) are configured rigidly and pivotable to each other.

6. The seal as set forth in any of the claims 1 to 5, characterized in that the seal is configured as a frame seal (14) for the moveable window pane (13) of a vehicle door (10).

7. The seal as set forth in any of the claims 1 to 6, characterized in that the latching element (16) is provided with two elastically pivotable tongues (19, 20).

8. The seal as set forth in claim 7, characterized in that the two tongues (19, 20) are disposed at an angle (α) to each other.

9. The seal as set forth in claim 8, characterized in that the angle (α) between the two tongues (19, 20) corresponds to the angle (β) between two frame parts (28, 29) of the frame (12).

10. The seal as set forth in any of the claims 1 to 9, characterized in that the tongue (19; 20) is provided with an attachment (27) for contacting the protuberance (22; 23).

11. The seal as set forth in any of the claims 1 to 10, characterized in that the latching element (16) is made of metal or of a hard plastics material.
